(19) United States
(12) Patent Application Publication
(10) Pub. No.: US 2013/0278700 A1
(43) Pub. Date: Oct. 24, 2013

(54) IMAGE ERASING AND RECORDING MEDIUM HEATING APPARATUS

(71) Applicant: Toshiba Tec Kabushiki Kaisha, (US)

(72) Inventor: Tatsuhisa NARAOKA, Shizuoka (JP)

(21) Appl. No.: 13/794,356

(22) Filed: Mar. 11, 2013

Related U.S. Application Data
(60) Provisional application No. 61/612,225, filed on Mar. 16, 2012.

(51) Int. Cl. B41M 7/00

(52) U.S. Cl. CPC B41M 7/00
USPC 347/179

(57) ABSTRACT

An image erasing apparatus comprises a first heating transporting member that includes a first heating member and a first pressing member that forms a first nip with the first heating member. The image erasing apparatus further comprises a second heating transporting member arranged downstream from the first heating transporting member, the second heating transporting member including a second heating member and a second pressing member that forms a second nip with the second heating member. In the image erasing apparatus, the recording medium is transported from the first heating transport member in an exit direction different from a direction of insertion into the first nip, and the second heating transporting member is arranged at a position such that the second nip is located in the exit direction.

### CROSS-REFERENCE TO RELATED APPLICATION

This application is based upon and claims the benefit of priority from the provisional U.S. Patent Application 61/612,225 filed on Mar. 16, 2012; the entire contents of which are incorporated herein by reference.

### FIELD

Embodiments described herein relate to an erasing apparatus that carries out an erasing treatment for the image on the paper sheet with the image formed using an image forming apparatus.

### BACKGROUND

An erasing apparatus of the related art carries out a heat treatment to erase the color of an image that is formed on a sheet from a toner that can be erased when the sheet is heated to above a prescribed temperature.

The image erasing apparatus for erasing toner images formed on the two surfaces of a sheet has two roller pairs, each of which includes a heating roller and a pressing roller arranged to press the heating roller. First of all, the sheet is fed between the heating roller and the pressing roller of the first roller pair, so that the toner image on one surface of the sheet is erased. Then, the sheet is fed between the heating roller and the pressing roller of the second roller pair on the downstream side to erase the color on the other surface.

For the image erasing apparatus with this configuration, a jam may take place when the sheet is fed from the upstream first roller pair to the downstream second roller pair. This is undesirable.

### DESCRIPTION OF THE DRAWINGS

The accompanying drawings, which are incorporated in and include apart of this specification, illustrate an embodiment of the disclosure; together with the description, they serve to explain the principles of the disclosure.

FIG. 1 is a schematic diagram illustrating the configuration of the image erasing apparatus according to embodiments of the present disclosure.

FIG. 2 is a diagram illustrating the main portion of the erasing section shown in FIG. 1, according to a first embodiment.

FIG. 3 is a diagram illustrating the main portion of the erasing section shown in FIG. 1, according to a second embodiment.

FIG. 4 is a diagram illustrating the main portion of the erasing section shown in FIG. 1, according to a third embodiment.

FIG. 5 is a diagram illustrating the main portion of an erasing section in the related art.

### DETAILED DESCRIPTION

In general, each embodiment is an example that is illustrated in the accompanying drawings.

An image erasing apparatus according to an embodiment comprises a first heating transporting member that includes a first heating member configured to heat a toner image formed on a first surface of a recording medium, and a first pressing member that forms a first nip with the first heating member and that works together with the first heating member to hold and transport the recording medium. The image erasing apparatus further comprises a second heating transporting member arranged downstream from the first heating transporting member, the second heating transporting member including a second heating member configured to heat a toner image formed on a second surface of the recording medium transported from the first heating transporting member, and a second pressing member that forms a second nip with the second heating member and which works together with the second heating member to hold and transport the recording medium. In the image erasing apparatus, the recording medium is transported from the first heating transport member in an exit direction different from a direction of insertion into the first nip, and the second heating transporting member is arranged at a position such that the second nip is located in the exit direction.

An image erasing apparatus according to an embodiment comprises a first heating conveying roller pair that includes a first heating roller configured to heat a toner image formed on a first surface of a recording medium, and a first pressing roller that forms a first nip with the first heating roller and that works together with the first heating roller to hold and convey the recording medium. The image erasing apparatus further comprises a second heating conveying roller pair arranged downstream from the first heating conveying roller pair, the second heating conveying roller pair including a second heating roller configured to heat a toner image formed on a second surface of the recording medium transported from the first heating conveying roller pair, and a second pressing roller that forms a second nip with the second heating roller and which works together with the second heating roller to hold and convey the recording medium. In the image erasing apparatus, the recording medium is conveyed from the first heating conveying roller pair in an exit direction different from a direction of insertion into the first nip, and the second heating conveying roller pair is arranged at a position such that the second nip is located in the exit direction.

In additional embodiments, a recording medium heating apparatus is provided. The recording medium heating apparatus comprises a first heating transporting member that includes a first heating member configured to heat a first surface of a recording medium, and a first pressing member that forms a first nip with the first heating member and that works together with the first heating member to hold and transport the recording medium. The recording medium heating apparatus further comprises a second heating transporting member arranged downstream from the first heating transporting member, the second heating transporting member including a second heating member configured to heat a second surface of the recording medium transported from the first heating transporting member, and a second pressing member that forms a second nip with the second heating member and that works together with the second heating member to hold and transport the recording medium. In the recording medium heating apparatus, the recording medium is transported from the first heating transport member in an exit direction different from a direction of insertion into the first nip, and the second heating transporting member is arranged at a position such that the second nip is located in the exit direction.

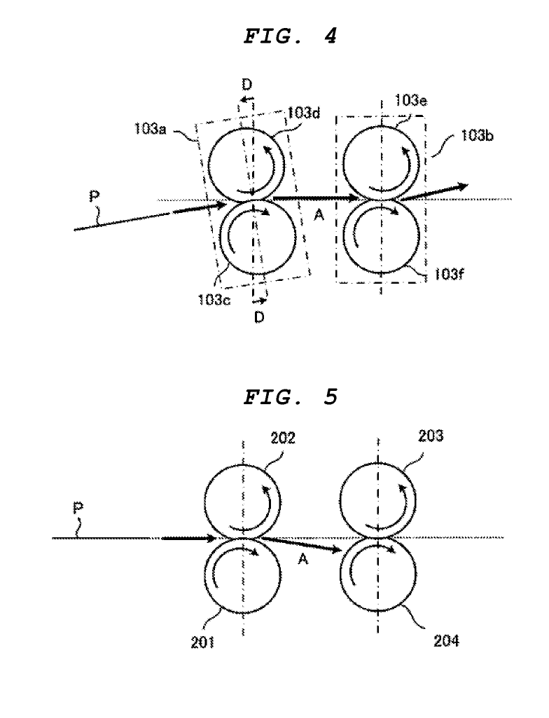

FIG. 4, discussed further below is a diagram illustrating the main portion of an erasing section 200 contained in the image erasing apparatus, according to an embodiment. When a pair of rollers is formed as a combination of 2 rollers, each having different hardness values, there is a tendency that the recording medium is ejected towards the side of the roller having the greater hardness. That is, when the roller having the lesser hardness is pressed on the roller having the greater hardness, the outer peripheral surface of the roller with the lower hardness deforms to a shape along the arc of the harder roller. Consequently, the sheet P is ejected in a shape along the tangential direction of the arc of the harder roller. When the recording medium enters to the side of the harder roller with lower surface resistance, there is also less hindrance on the transportation of the medium.

As shown in FIG. 5, illustrating a prior art arrangement, for the roller pair including a heating roller 201 and a pressing roller 202, the heating roller 201 is harder. Consequently, the sheet P is ejected in the direction (the direction indicated by the arrow A) along the tangential line of the outer peripheral surface of the heating roller 201. Thus, the sheet P is transported in a manner hitting the pressing roller 204 among the roller pair of a heating roller 203 and the pressing roller 204 on the downstream side of the conveying path. In consideration of this fact, a transporting guide must be arranged between the upstream roller pair and the downstream roller pair as a means for restraining the transporting direction of the recording medium.

However, when such a transporting guide is arranged, a corresponding space is occupied, which hampers the effort to decrease the size of the device itself while also increasing the cost. In addition, as the transporting guide disperses the heat in the erasing section, the energy efficiency is poor for the erasing treatment.

According to the present embodiment, a configuration is made in consideration of the direction of the ejection of the recording medium ejected from the upstream roller pair when the erasing apparatus is manufactured, so that even when the transporting guide is not properly arranged, it is still possible to transfer the recording medium to the downstream roller pair.

In the following, the presently disclosed embodiments will be explained with reference to figures. The same numerals and signs will be adopted throughout the following explanation of the configuration and functions.

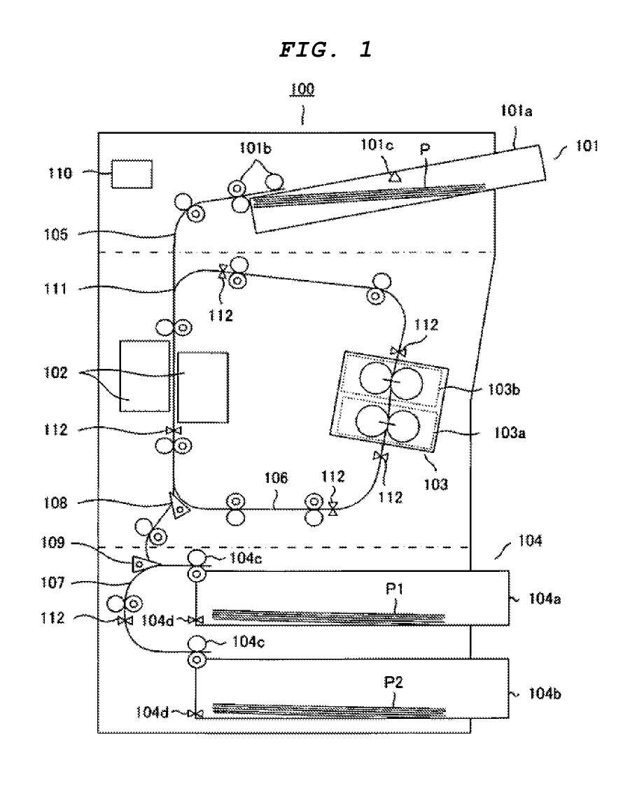

FIG. 1 is a schematic diagram illustrating the overall configuration of the image erasing apparatus according to the present embodiment. Here, an image erasing apparatus 100 carries out the erasing treatment to erase the color of the image on the sheet P as the recording medium where the image is formed from a decolorable toner or a decolorable ink or another decolorable coloring material. The image erasing apparatus 100 has a paper feeding section 101, a read section 102, an erasing section 103, a paper discharge section 104, a first conveying path 105, a second conveying path 106, a third conveying path 107, a first branching member 108, a second branching member 109, and a control section 110.

The paper feeding section 101 includes a paper feeding tray 101a and a paper feeding member 101b. The sheets P for reuse are stacked on the paper feeding tray 101a. The paper feeding tray 112 can carry sheets in various sizes, such as A4, A3, B5, and the like, which are stacked on the paper feeding tray 101a. The sheets P stacked on the paper feeding tray 101a have images formed on them from a recording material that can be erased when heated over a prescribed temperature. The paper feeding member 101b includes a pickup roller, a sheet supply roller, and a separating roller arranged facing the sheet supply roller. The sheets P on the paper feeding tray 101a are fed one sheet at a time to the first conveying path 105 inside of the image erasing apparatus 100. Also, the paper feeding tray 101a has a detecting sensor 101c for detecting the presence/absence of the sheet in the paper feeding tray 101a. For example, the detecting sensor 101c may be a microsensor or a microactuator.

The read section 102 is arranged along the first conveying path 105 and on the downstream side from the paper feeding tray 101a in the sheet transporting direction. The read section 102 includes, for example, a CCD (Charge Coupling Device) scanner or a CMOS scanner or another read unit. The read section 102 reads the images on the first surface and the second surface of each sheet P being transported. That is, the read section 102 has 2 read units arranged with the first conveying path 105 sandwiched between them. The read section can read the images on the two sides of the sheet P being transported. The images read by the read section 102 are stored in a memory, which is to be explained later, in the control section 110. For example, the images on the sheet read by the read section 102 before the erasing treatment are stored as electronic data in the memory, so that the image data can be obtained when needed later. Also, on the basis of the image read by the read section 102, the control section 110 can determine whether the sheet is an erasable sheet and/or a whether the sheet is a reusable sheet.

On the downstream side of the read section 102, there is the first branching member 108 as a switching section. The first branching member 108 switches the sheet transporting direction. The first branching member 108 can transport the sheet transported in the first conveying path 105 to the paper discharge section 104 or the second conveying path 106. The second conveying path 106 branches from the first conveying path 105 at the branching point where the first branching member 108 is arranged. The second conveying path 106 branched from the branching point transports the sheet P to the erasing section 103.

The erasing section 103 erases the color of the image on the sheet P being transported. While in contact with the sheet P being transported, the erasing section 103 heats the sheet P to the prescribed erasing temperature, so that the color of the image formed on the sheet is erased. The erasing section 103 can carry out the erasing treatment for the two sides of the sheet P.

The erasing section 103 has a first heating transporting member 103a and a second heating transporting member 103b, which hold and transport the sheet P. The second heating transporting member 103b is arranged to match the direction of the sheet P ejected from the first heating transporting member 103a. The sheet P is held and transported by the first heating transporting member 103a so that one side of the sheet (hereinafter to be referred to as the “first surface”) is erased. Then, the sheet is held and transported by the second heating transporting member 103b on the downstream side, so that the other side (hereinafter to be referred to as the “second surface”) of the sheet is erased. That is, the erasing section 103 can erase the images on both sides of the sheet P being transported in a single round of transportation.

The paper discharge section 104 has a first paper discharge tray 104a, a second paper discharge tray 104b, and a paper discharge member 104c. Here, the first paper discharge tray 104a is arranged at a position below the second paper discharge tray 104b.

The first paper discharge tray 104a and the second paper discharge tray 104b each have a stacked sheet detecting sensor 104d. The stacked sheet detecting sensor 104d detects whether the number of the stacked sheets has reached the tolerable number of sheets for the first paper discharge tray 104a or the second paper discharge tray 104b, and if so, sends a signal to the control section 110. The stacked sheet detecting sensor 104d may be a microsensor or a microactuator.

The sheets P1 that have the images on the sheets P erased and that can be reused are stacked on the first paper discharge tray 104a. The sheets P2 determined to be non-reusable are stacked on the second paper discharge tray 104b. The paper discharge member 104c exhausts paper sheets P1 and P2 to the first paper discharge tray 104a and the second paper discharge tray 104b, respectively. For the first paper discharge tray 104a and the second paper discharge tray 104b, it is possible to change the sheets as the objects to be received. The control section 110 may be used to set which paper discharge tray is to receive which type of sheets. In other words, the control section may be used to set the transporting destination of the sheets. Based on the setting, the second branching member 109 switches the conveying path, so that the transported sheet is guided to the first paper discharge tray 104a or the third conveying path 107.

The first conveying path 105 forms a conveying path from the paper feeding tray 101a to the first paper discharge tray 104a. The first conveying path 105 transports the fed sheet to the read section 102 and/or to the first paper discharge tray 104a. The first conveying path 105 has the second branching member 109 downstream from the first branching member 108. The second branching member 109 guides the sheet transported from the first branching member 108 to the first paper discharge tray 104a or to the third conveying path 107. The third conveying path 107 transports the sheet P2 to the second paper discharge tray 104b.

The second conveying path 106 merges with the first conveying path 105 at the merging point 111 upstream from the read section 102 in the sheet transporting direction. That is, the second conveying path 106 merges with the first conveying path 105 at the merging point 111 between the paper feeding section 101 and the read section 102. Consequently, the second conveying path 106 can transport the sheet P transported from the read section 102 via the erasing section 103 to the read section 102 again. In other words, the image erasing apparatus 100 can control the first branching member 108 to transport the sheet P fed from the paper feeding section 101 to the read section 102, to the erasing section 103, and again to the read section 102 in that order.

The control section 110 includes a processor made of a CPU (Central Processing Unit) or an MPU (Micro Processing Unit) and a memory. The control section 110 controls the overall treatments carried out in the image erasing apparatus 100, that is, the treatments carried out in the paper feeding section 101, the read section 102, the erasing section 103, the paper discharge section 104, and the like. The memory is, for example, a semiconductor memory. The memory has a ROM (Read-Only Memory) that stores the various types of control programs and a RAM (Random Access Memory) that provides a temporary operation region for the processor. For example, the ROM may store the sheet's printing rate as the threshold in determining the yes/no property of reusability, the density threshold for determining whether the image can be erased, and the like. The RAM may also temporarily store the image read by the read section 102.

The conveying path for the sheet P can be changed appropriately corresponding to the treatment mode executed by the image erasing apparatus 100. The image erasing apparatus 100 has plural treatment modes. For example, the image erasing apparatus 100 has the following modes: (1) a first erasing mode that carries out only the erasing treatment without carrying out the image read function; (2) a second erasing mode that carries out the erasing treatment after reading the image; (3) a third erasing mode that determines whether the sheet P can be reused (separating treatment) after the erasing treatment, without the read treatment before erasing; (4) a fourth erasing mode that carries out the erasing treatment after reading the image and then carries out the separating treatment; (5) a read mode that carries out image read treatment without carrying out the decoloration of the image; and the like. These modes can be selected by the operation panel of the image erasing apparatus 100 or from the external terminal. In these erasing modes, the sheet P is transported to the erasing section 103. On the other hand, in the read mode, the image erasing apparatus 100 controls the first branching member 108 so that the sheet P is ejected via the read section 102 without transporting the sheet P to the erasing section 103.

The image erasing apparatus 100 includes plural sheet detecting sensors 112 that detect positions of the sheet through the first, second and third conveying paths 105, 106, and 107. Here, for example, the sheet detecting sensors may be microsensors or microactuators. The sheet detecting sensors are arranged at appropriate positions along the conveying path.

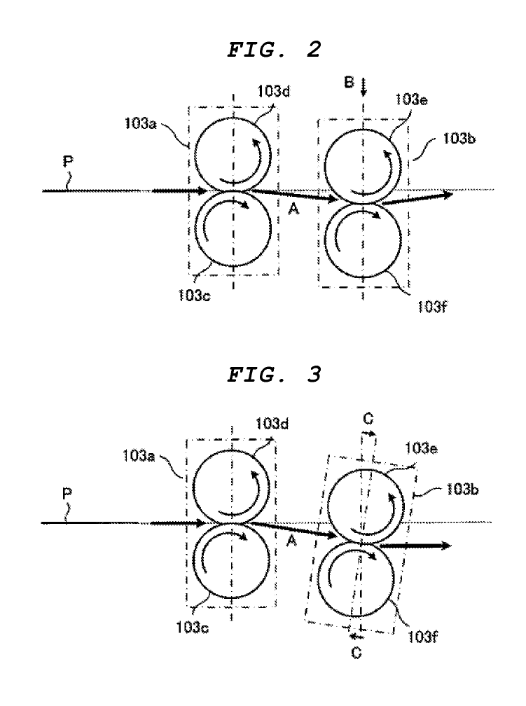

FIG. 2 is a diagram illustrating the configuration of the main portion of the erasing section 103, according to a first embodiment. As shown in FIG. 2, the erasing section 103 includes a first heating transporting member 103a and a second heating transporting member 103b. The second heating transporting member 103b is arranged on the downstream side from the first heating transporting member 103a in the transporting direction of the sheet P. The first heating transporting member 103a includes a roller pair (the first heating conveying roller pair). The first heating conveying roller pair includes a heating roller 103c (the first heating member) for heating the first surface of the sheet P and a pressing roller 103d (the first pressing member) arranged facing the heating roller 103c and pressed on the heating roller 103c. The heating source of the heating roller 103c is, for example, a halogen lamp or the like arranged on the inner side of the heating roller 103c. The first heating roller 103c is made of a material with a lower surface resistance and a greater hardness than the first pressing roller 103d. As the sheet P passes between the first heating roller 103c and the first pressing roller 103d, i.e., the nip section between the first heating roller 103c and the first pressing roller 103d, the toner image formed on the first surface of the sheet P is erased.

The second heating transporting member 103b includes a roller pair (the second heating conveying roller pair). The second heating conveying roller pair includes a heating roller 103e (the second heating member) for heating the second surface of the sheet P. The second heating roller 103e is arranged on the opposite side of the first heating roller 103c with respect to the sheet P. The second heating conveying roller pair also includes a pressing roller 103f (the second pressing member) arranged facing the heating roller 103e and pressed on the heating roller. The second heating transporting member 103b is formed with an orientation opposite to that of the first heating transporting member 103a. The second heating roller 103e is made of a material with a lower surface resistance and a greater hardness than the second pressing roller 103f.

The second heating transporting member 103b is arranged at a position downstream—for example, by about 60 mm,—from the first heating transporting member 103a in the sheet transporting direction. That is, the interval between the first heating transporting member 103a and the second heating transporting member 103b is about 60 mm. This interval is an interval at which the sheet with the smallest size can be held simultaneously by both the first heating transporting member 103a and the second heating transporting member 103b at the same time.

The sheet P conveyed into the first heating transporting member 103a is ejected from the first heating roller 103c side (FIG. 2, indicated by arrow A). The second heating transporting member 103b matches the direction of the sheet P ejected from the first heating transporting member so that the sheet is conveyed to the nip portion between the second heating roller 103e and the second pressing roller 103f. In other words, the sheet P is conveyed to the nip section between the second heating roller 103e and the second pressing roller 103f. According to the present embodiment, because the heating roller 103e is made of a material with a lower surface resistance than that of the pressing roller 103f, the sheet P ejected from the first heating transporting member 103a is conveyed to the second heating transporting member 103b towards the second heating roller 103e side. As a result, it is possible to prevent the problem of jamming. The second heating transporting member 103b is arranged at the position displaced in a direction (FIG. 2, indicated by arrow B) orthogonal to the inserting direction of the sheet P to the first heating transporting member 103a. The displacement is selected appropriately so that the nip portion of the second heading transporting member 103b matches the discharge direction of the sheet P ejected from the first heating transporting member 103a.

The straight line passing through the central axes of the first heating roller 103c and the first pressing roller 103d that form the first heating transporting member 103a is parallel with the central axis of the second heating roller 103e and the second pressing roller 103f.

As explained above, by arranging the second heating transporting member 103b in a displaced position as described, the sheet P that has passed through the first heating transporting member 103a can pass through the nip portion of the second heating transporting member 103b smoothly. Thus, it is possible to erase the toner image formed on the second surface of the sheet P without a jam.

The first heating roller 103c and the second heating roller 103e each have a temperature sensor for measuring the surface temperature. The detected information is output to the control section 110. On the basis of the information input into the control section 110, the supply current to the heating sources is controlled. As a result of such control, their surface temperatures become nearly equal to each other.

According to the second embodiment shown in FIG. 3, the second heating transporting member 103b is arranged at a position rotated by a prescribed angle around the sheet inserting position corresponding to the nip portion of the second heating transporting member 103b. The second heating transporting member 103b is rotated with respect to the discharge direction of the sheet P ejected from the first heating transporting member (the tangential direction of the outer peripheral surface of the first heating roller 103c in contact with the first pressing roller 103d). As can be seen, it is possible to have the direction that the sheet P is ejected from the second heating transporting member 103b to be essentially parallel with respect to the direction of insertion of the sheet P in the first heating transporting member 103a.

For example, as shown in FIG. 3, after the second heating transporting member 103b is moved in the perpendicular direction relative to the sheet conveying direction of the sheet P inserted in the first heating transporting member 103a, the nip portion of the second heating transporting member 103b is further rotated clockwise (in the direction indicated by arrow C) from the central axis. Thus, because the ejection direction from each of the heating transporting members 103a and 103b is tangential to the surface of the heating rollers 103c and 103e, the direction in which the sheet P is inserted in the first heating transporting member 103a and the direction in which the sheet is ejected from the second heating transporting member 103b can be nearly parallel with each other.

When the conveying path located downstream from the second heating transporting member 103b is nearly parallel to the direction of the insertion of the sheet P in the first heating transporting member 103a, such as with the arrangement shown in FIG. 3, the sheet, after passing through the second heating transporting member 103b, is ejected from the second heating transporting member 103b in a direction nearly parallel with the direction of insertion in the first heating transporting member 103a. Consequently, in the direction of the conveying path located downstream from the second heating transporting member 103b, the nearly parallel relationship exists, so that it is possible to suppress the jamming of the sheet P after passing through the second heating transporting member 103b.

As can be seen in FIG. 4, the first heating transporting member 103a can be moved with the nip portion as the axis. With this configuration, the sheet, after passing through the second heating transporting member 103b, can be nearly parallel with the direction of insertion in the first heating transporting member 103a.

For example, as shown in FIG. 4, the first heating transporting member 103a is rotated counter-clockwise (in the direction indicated by arrow D) with the nip portion as the axis. Thus, because the ejection direction from each of the heating transporting members 103a and 103b is tangential to the surface of the heating rollers 103c and 103e, the direction of insertion of the sheet P in the first heating transporting member 103a and the direction of ejection from the second heating transporting member 103b can be nearly parallel with each other. Consequently, when the transporting direction of the conveying path after passing the erasing section 103 (after ejection from the second heating transporting member 103b) is nearly parallel with the direction of insertion of the sheet P in the first heating transporting member 103a, with the constitution shown in FIG. 4, the sheet discharge direction and the direction of the conveying path after passing the erasing section are nearly parallel with each other. Thus, it is possible to suppress the jamming of the sheet P after passing through the erasing section.

That is, by predefining the configuration of the roller pairs in consideration of the discharge direction of the sheet P ejected after passing through a roller pair with different hardness values, it is possible to suppress the jamming of the sheet after the sheet passes through the erasing section.

As long as the present embodiment is observed, the heating members and the pressing members of the erasing section 103 can be changed. For example, in the embodiment, the first and second heating members and the first and second pressing members are both rollers. However, one may also adopt a scheme in which rollers/belts, belts/belts, and the like, are adopted. In addition, the image erasing apparatus of the present embodiment may also be incorporated in an image forming apparatus. For example, the disclosed configuration of two pairs of heat and pressing rollers may be utilized in a fixing section of an image forming apparatus, in which toner images transferred to both sides of a recording medium are fixed with two sets of heating and pressing rollers, similar to the above-described erasing section 103.

While certain embodiments have been described, these embodiments have been presented by way of example only, and they are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image erasing apparatus comprising:
a first heating transporting member including a first heating member configured to heat a toner image formed on a first surface of a recording medium, and a first pressing member that forms a first nip with the first heating member and that works together with the first heating member to hold and transport the recording medium; and
a second heating transporting member arranged downstream from the first heating transporting member, the second heating transporting member including a second heating member configured to heat a toner image formed on a second surface of the recording medium transported from the first heating transporting member, and a second pressing member that forms a second nip with the second heating member and which works together with the second heating member to hold and transport the recording medium, wherein
the recording medium is transported from the first heating transport member in an exit direction different from a direction of insertion into the first nip, and
the second heating transporting member is arranged at a position such that the second nip is located in the exit direction.

2. The image erasing apparatus according to claim 1, wherein the second nip is arranged at a position displaced perpendicular to the direction of insertion into the first nip.

3. The image erasing apparatus according to claim 2, wherein the second heating transporting member is further arranged at a position rotated about the second nip with respect to a direction perpendicular to the direction of insertion into the first nip such that a direction of discharge from the second heating transporting member is parallel to the direction of insertion into the first nip.

4. The image erasing apparatus according to claim 1, wherein the second heating transporting member is arranged at a position rotated about the second nip with respect to a direction perpendicular to the direction of insertion into the first nip.

5. The image erasing apparatus according to claim 1, wherein
the first heating transporting member is arranged at a position rotated about the first nip with respect to a direction perpendicular to the exit direction.

6. The image erasing apparatus according to claim 1, wherein
the first and second heating members are heating rollers;
the first and second pressing members are pressing rollers; and
the second heating member is located on the opposite side of the recording medium being transported relative to the first heating member.

7. The image erasing apparatus according to claim 1, wherein the first heating transporting member and the second heating transporting member are configured to hold the recording medium at the same time.

8. An image erasing apparatus comprising:
a first heating conveying roller pair including a first heating roller configured to heat a toner image formed on a first surface of a recording medium, and a first pressing roller that forms a first nip with the first heating roller and that works together with the first heating roller to hold and convey the recording medium; and
a second heating conveying roller pair arranged downstream from the first heating conveying roller pair, the second heating conveying roller pair including a second heating roller configured to heat a toner image formed on a second surface of the recording medium transported from the first heating conveying roller pair, and a second pressing roller that forms a second nip with the second heating roller and which works together with the second heating roller to hold and convey the recording medium, wherein
the recording medium is conveyed from the first heating conveying roller pair in an exit direction different from a direction of insertion into the first nip, and
the second heating conveying roller pair is arranged at a position such that the second nip is located in the exit direction.

9. The image erasing apparatus according to claim 8, wherein a straight line passing through the central axes of the rollers of the second heating conveying roller pair is parallel with a straight line passing through the central axes of the rollers of the first heating conveying roller pair.

10. The image erasing apparatus according to claim 8, wherein a straight line passing through the central axes of the rollers of the second heating conveying roller pair is rotated about the second nip with respect to a direction perpendicular to the direction of insertion into the first nip.

11. The image erasing apparatus according to claim 10, wherein the second nip is further arranged at a position displaced perpendicular to the direction of insertion into the first nip the such that a direction of discharge from the second heating conveying roller pair is parallel to the direction of insertion into the first nip.

12. The image erasing apparatus according to claim 8, wherein a straight line passing through the central axes of the rollers of the first heating conveying roller pair is rotated about the first nip with respect to a direction perpendicular to the exit direction.

13. The image erasing apparatus according to claim 8, wherein the second heating roller is located on the opposite side of the recording medium being conveyed relative to the first heating member.

14. The image erasing apparatus according to claim 8, wherein the first heating conveying roller pair and the second heating conveying roller pair are configured to hold the recording medium at the same time.

15. A recording medium heating apparatus comprising:
a first heating transporting member including a first heating member configured to heat a first surface of a recording medium, and a first pressing member that forms a first nip with the first heating member and that works together with the first heating member to hold and transport the recording medium; and
a second heating transporting member arranged downstream from the first heating transporting member, the second heating transporting member including a second heating member configured to heat a second surface of the recording medium transported from the first heating transporting member, and a second pressing member that forms a second nip with the second heating member and that works together with the second heating member to hold and transport the recording medium, wherein
the recording medium is transported from the first heating transport member in an exit direction different from a direction of insertion into the first nip, and
the second heating transporting member is arranged at a position such that the second nip is located in the exit direction.

16. The recording medium heating apparatus according to claim 15, wherein the second nip is arranged at a position displaced perpendicular to the direction of insertion into the first nip.

17. The recording medium heating apparatus according to claim 16, wherein the second heating transporting member is further arranged at a position rotated about the second nip with respect to a direction perpendicular to the direction of insertion into the first nip such that a direction of discharge from the second heating transporting member is parallel to the direction of insertion into the first nip.

18. The recording medium heating apparatus according to claim 15, wherein
the first heating transporting member is arranged at a position rotated about the first nip with respect to a direction perpendicular to the exit direction.

19. The recording medium heating apparatus according to claim 15, wherein
the first and second heating members are heating rollers;
the first and second pressing members are pressing rollers; and
the second heating member is located on the opposite side of the recording medium being transported relative to the first heating member.

20. The image erasing apparatus according to claim 15, wherein the first heating transporting member and the second heating transporting member are configured to hold the recording medium at the same time.
